(19) United States
(12) Patent Application Publication
(10) Pub. No.: US 2021/0138812 A1
(43) Pub. Date: May 13, 2021

(54) SAFETY INTERLOCK MECHANISMS

(71) Applicant: HEWLETT-PACKARD DEVELOPMENT COMPANY, L.P., SPRING, TX (US)

(72) Inventors: Javier Gonzalez, Sant Cugat del Valles (ES); Roger Bastardas, Sant Cugat del Valles (ES); Fernando Bayona, Sant Cugat del Valles (ES)

(73) Assignee: HEWLETT-PACKARD DEVELOPMENT COMPANY, L.P., SPRING, TX (US)

(21) Appl. No.: 16/623,733

(22) PCT Filed: Sep. 29, 2017
(86) PCT No.: PCT/US2017/054269

§ 371 Date: Dec. 17, 2019

(51) Int. Cl. B41J 29/58; B41J 2/175

(52) U.S. Cl. CPC B41J 29/58; B41J 2/1753

(57) ABSTRACT

It is disclosed a safety interlock mechanism that comprises: a plurality of interlock switches having a first contact and a second contact; an actuator mechanically coupled to each interlock switch, the actuator having an active position wherein the actuator acts on the switch so that the first contact is in conductive state and having a passive position wherein the actuator acts on the switch so that the second contact is in conductive state; and a detection circuit connected one of the interlock switches; wherein the plurality of interlock switches are connected in series through the first contact and the detection circuit is connected to the second contact being the detection circuit an active circuit to determine the position of the actuator.

### BACKGROUND

Equipment and machinery is often capable of injuring a user when it is operated unsafely. For example, a printing system may can cause injury if it is operated with a cover or a door open, e.g., a cover or a door located in a compartment such as a compartment within a carriage. Therefore, the open cover or door can be considered as an unsafe condition. Safety interlock mechanisms are designed to prevent equipment and machinery from operating when an unsafe condition exists.

### BRIEF DESCRIPTION OF THE DRAWINGS

Examples will now be described, by way of non-limiting examples, with reference to the accompanying drawings, in which:

FIG. 1 shows a system including a safety interlock mechanism according to an example.

FIG. 2 shows a system including a safety interlock mechanism according to another example.

FIG. 3 shows a system including a safety interlock mechanism according to a further example.

### DETAILED DESCRIPTION

Safety interlock mechanisms are mechanisms that comprise a set of switches mechanically coupled to and/or actuated by a part of a system such as, e.g., a door and electrically coupled to a relay and/or a load. The main purpose of the safety interlock mechanism is to prevent a load from being powered if a safety condition is not fulfilled, e.g., if a door is open.

Safety interlock mechanisms are relevant mechanisms within any device that may potentially cause risk on a user. Interlock mechanisms are of such an importance that several jurisdictions recommend specific certifications to be able to sell products including them.

It is useful for safety interlock mechanisms to comply with several certifications to prevent their malfunction and, furthermore, it is a further feature for interlock mechanisms comprising a plurality of switches to be able to determine the status of each of the switches as to have the ability to warn the user exactly which switch of the set of switches presents the unsafe situation.

In the foregoing, reference is made to the accompanying drawings. The examples in the description and drawings should be considered illustrative and are not to be considered as limiting to the specific example or element described. Multiple examples may be derived from the following description and/or drawings through modification, combination or variation of certain elements. Although certain features are shown and described in conjunction they may be applied separately, also if not specifically claimed. Furthermore, it may be understood that examples or elements that are not literally described may be derived from the description and drawings by a person of ordinary skill in the art.

FIG. 1 shows an example of a system comprising an interlock mechanism 1 according to a first example. In the example of FIG. 1 the interlock mechanism 1 comprises a plurality of switches 50, 51, 52 that are serially connected, i.e., the first switch 50 is connected to the second switch 51 by a first intermediate node 53 and the second switch 51 is connected to the third switch 52 by a second intermediate node 54. In the example of FIG. 1, the switches are SPDT (Simple Pole Double Throw) and the serial connection between switches may be performed by using the first contact of the switch (one of the ‘throw’ connections of the switch), for example, the normally open contact.

The switches 50, 51, 52 are coupled to an actuator 20, 21, 22 for example, mechanically coupled. In the example of FIG. 1, an action by the actuator moves the switches 50, 51, 52 thereby acting on the switch so that, when the actuator is on a passive position (as shown in FIG. 1) the first contact is open (in a non-conductive state) and the second contact is closed (in a conductive state). On the other hand, when the actuator is moved to an active position, the first contact moves to a conductive state and the second contact moves to a non-conductive state. In an example, the actuator is associated to a cover of a compartment so that an open door in the compartment leaves the actuator in a passive state whereas if the door is closed the actuator is moved to an active position.

Further, the interlock mechanism is connected, on one side to a source Vᵢₙ and, on the other side to a relay 41 which upon receiving a voltage from the source Vᵢₙ energizes a circuit 42.

Since the interlock mechanism 1 comprises a set of serially connected switches, it suffices that one of the switches 50, 51, 52 does not have the contact towards the relay 41 in a conductive state to de-energize the relay and, as a consequence, disable the circuit 42. It is useful to de-energize a relay if an unsafe condition occurs and, further, it is also useful to know specifically where the unsafe condition occurred, i.e., which switch is not in conductive state.

Therefore, the interlock mechanism 1 comprises a detection circuit 3 associated to at least one of the switches 50, 51, 52 and connected to its second contact, e.g., the normally closed contact. The detection circuit 3 according to an example is a detection circuit that is isolated from the relay 41 as to prevent that a malfunction of the detection circuit erroneously activates it. In FIG. 1, the detection circuit is always a circuit isolated from the relay as their location on a separate contact from the SPDT switches maintains such isolation.

The detection circuit 3 is, in an example, an active circuit, i.e., a circuit comprising an energy source. In a further example, the detection circuit is a circuit able to inject a current through the switches 50, 51, 52 while the switches are conductive in the contact that is connected to the detection circuit 3, i.e., the second contact. In such an example, the circuit may comprise a set of auxiliary resistors 500, 501, 502 on the intermediate nodes 53, 54 to close the detection circuit when the second contact is active.

FIG. 2 shows an example of an interlock mechanism 1 wherein the detection circuit is an active circuit that comprises a detector source 31 that applies a voltage V_{M} through a measurement resistor 32. In this particular example, when the first contact is active (no unsafe condition) the first switch 50 is not acted upon by the first actuator 20 and, therefore, the detection circuit 3 is open, i.e., there is no voltage drop through the measurement resistor 32 and the detection circuit may determine that no unsafe condition is associated to the first switch 50.

If there is an unsafe condition, the first actuator 20 acts on the first switch 50 and closes the detection circuit 3. Then, if V_{M} is a voltage higher than Vᵢ, (for example 110% Vᵢ or 110% higher than the maximum voltage calculated for the corresponding intermediate node) a current flow occurs from the detector source 31 through the measurement resistor 32, the second contact of the switch 50, and the auxiliary resistor 500. In this case, a voltage drop occurs on the measurement resistor 32 which is indicative that an unsafe condition may be occurring on the compartment associated to the first actuator 20.

In this case, a voltage measurement circuit connected to the measurement resistor 32 may be used to establish that the first switch 50 is detecting an unsafe condition. This same working principle can be extended to the second actuator 21 and the third 22.

A relevant feature of having an active detection circuit 3 is that, even if the adjacent serially connected switches are open, the circuit is able to inject a current to the intermediate node 53, 54, while it is isolated from the relay 41 and, in consequence, allows for a safe measurement.

FIG. 3 shows another example wherein the interlock mechanism 1 comprises a detection circuit 3 that, in turn, comprises a transistor 34 in a switch configuration.

The detection circuit 3 of FIG. 3 comprises a BJT (bipolar junction transistor) 34 of the PNP type with a weak pull-up resistor 36 connected between the gate and the emitter and a drain resistor 37 connected to the second contact of the switches 50, 51, 52. Further a source 31 is connected to the emitter of the transistor 34.

In the foregoing, to explain the working principle of the detection circuit, reference will be made to the second switch 51, however, a similar functioning applies to other switches within the interlocking mechanism 1.

On the first condition, if the second actuator 21 is on an active position the switch is on a position wherein the first contact is in conductive state. In this case, the drain resistor 37 does not close a circuit so there is no voltage drop on the emitter -base of the transistor 34, therefore, the transistor is on an off state and there is also no current trough the collector-drain arrangement of the transistor. Therefore, a detector 33 connected to the drain will detect a zero.

On the second condition, if the second actuator 21 is on passive state, the switch moves to a position wherein the second contact is in conductive state. In this case, the drain resistor 37 closes the circuit together with at least one of the auxiliary resistors 500, 501, 502.

Even thought, the example of FIG. 3 has been disclosed with reference to a BJT transistor, the same approach can be performed using other types of transistors as long as they are able to work in a switch mode such as, e.g., field effect transistors (FET).

An example safety interlock mechanism comprises:
a plurality of interlock switches having a first contact and a second contact;
an actuator mechanically coupled to each interlock switch, the actuator having an active position wherein the actuator acts on the switch so that the first contact is in a conductive state and having a passive position wherein the actuator acts on the corresponding interlock switch such that the second contact is in a conductive state; and
a detection circuit to connect to a first interlock switch of the plurality of the interlock switches;
   wherein the plurality of interlock switches are connected in series through the first contact and the detection circuit is connected to the second contact being the detection circuit an active circuit to determine whether the actuator is in the active position or in the passive position. The switches may be, e.g., SPDT switches so that one of the throw contacts may be connected to the pole at the same time.

In an example, the mechanism comprises a plurality of detection circuits connected to the plurality of interlock switches.

Also, the detection circuit may issue a detection signal to be communicated to a controller, the detection signal can be further used to prompt the user of an unsafe condition, to trigger an alert, and/or to trigger additional protection circuits.

In a further example, the actuator is mechanically coupled to a cover or a door. In this case, the unsafe condition may be that a door is open, i.e., the actuator is coupled to the door so that an open door does not activate the actuator and a closed door activates it.

As for the electronics, the detection circuit may comprise a transistor in a switch configuration. For example, the transistor may be a PNP bipolar junction transistor with a base-emitter connection and with the base connected to the interlock switch, the emitter connected to a supply source and the issuing a detection signal. In another example, the transistor may be a P-channel field effect transistor with a source-gate connection and with the gate connected to the interlock switch, the source connected to a supply source and the drain issuing a detection signal.

In the mechanism, the plurality of interlock switches may be serially connected by an intermediate node and the detection circuit may comprise a supply source with a voltage higher than a highest voltage of the intermediate node. For example, the supply source is a source with a voltage higher than 110% the highest voltage of the intermediate node.

An example printing system comprises a plurality of compartments with respective covers and a safety interlock mechanism comprising:
a plurality of interlock switches having a normally open contact and a normally closed contact;
an actuator mechanically coupled to each interlock switch, the actuator having an active position wherein the first contact is in conductive state and a passive position wherein the second contact is in conductive state; and
a detection circuit connected one of the interlock switches;
   wherein the actuators are coupled to the covers so that a closed position of the covers modifies the position of the actuator to the active position and wherein the plurality of interlock switches are connected in series through one of the contacts and the detection circuit is connected to the other contact being the detection circuit to inject a current from the detection circuit through the second contact when the actuator is on the passive position.

In an example, the compartments are selected from: printing agent storage, carriage, moving parts than can trap the operator, etc.

In a further example, the detection circuit is connected to each of the plurality of interlock switches.

The system may also comprise a controller to receive a detection signal from the detection circuit. The detection signal may be use as an alert or as a trigger to another circuit. Further, the controller may issue a prompt signal to the user when the detection circuit determines a change in the position of the actuator.

In an example, the detection circuit comprises a transistor in a switch configuration. The transistor may be, e.g., a transistor in a switch configuration.

1. A safety interlock mechanism that comprises:
a plurality of interlock switches having a first contact and a second contact;
an actuator mechanically coupled to each interlock switch, the actuator having an active position wherein the actuator acts on the switch so that the first contact is in a conductive state and having a passive position wherein the actuator acts on the corresponding interlock switch such that the second contact is in a conductive state; and
a detection circuit to connect to a first interlock switch of the plurality of the interlock switches;
wherein the plurality of interlock switches are connected in series through the first contact and the detection circuit is connected to the second contact being the detection circuit an active circuit to determine whether the actuator is in the active position or in the passive position.

2. The mechanism of claim 1 wherein the mechanism comprises a plurality of detection circuits connected to the plurality of interlock switches.

3. The mechanism of claim 1 wherein the detection circuit issues a detection signal to be communicated to a controller.

4. The mechanism of claim 1 wherein the actuator is to be mechanically coupled to a cover or a door.

5. The mechanism of claim 1 wherein the detection circuit comprises a transistor in a switch configuration.

6. The mechanism of claim 5 wherein the transistor is a PNP bipolar junction transistor with a base-emitter connection and with the base connected to the interlock switch, the emitter connected to a supply source and the collector issuing a detection signal.

7. The mechanism of claim 5 wherein the transistor is a P-channel field effect transistor with a source-gate connection and with the gate connected to the interlock switch, the source connected to a supply source and the drain issuing a detection signal.

8. The mechanism of claim 1 wherein the plurality of interlock switches are serially connected by an intermediate node and the detection circuit comprises a supply source with a voltage higher than a highest voltage of the intermediate node.

9. The mechanism of claim 8 wherein the supply source is a source with a voltage higher than 110% the highest voltage of the intermediate node.

10. A printing system comprising a plurality of compartments with respective covers and a safety interlock mechanism comprising:
a plurality of interlock switches having a normally open contact and a normally closed contact;
an actuator mechanically coupled to each interlock switch, the actuator having an active position wherein the first contact is in conductive state and a passive position wherein the second contact is in conductive state; and
a detection circuit connected one of the interlock switches;
wherein the actuators are coupled to the covers so that a closed position of the covers modifies the position of the actuator to the active position and wherein the plurality of interlock switches are connected in series through one of the contacts and the detection circuit is connected to the other contact being the detection circuit to inject a current from the detection circuit through the second contact when the actuator is on the passive position.

11. The system of claim 10 wherein the compartments are one selected from:
printing agent storage, carriage, and/or moving parts than can trap the operator.

12. The system of claim 10 wherein the detection circuit is connected to each of the plurality of interlock switches.

13. The system of claim 10 wherein the system further comprises a controller to receive a detection signal from the detection circuit.

14. The system of claim 13 wherein the controller issues a prompt signal to the user when the detection circuit determines a change in the position of the actuator.

15. The system of claim 10 wherein the detection circuit comprises a transistor in a switch configuration.
